(19) United States
(12) Patent Application Publication
(10) Pub. No.: US 2023/0415168 A1
(43) Pub. Date: Dec. 28, 2023

(54) ULTRA-HIGH-SPEED ROTOR

(71) Applicant: FIBERLITE CENTRIFUGE LLC, Santa Clara, CA (US)

(72) Inventor: Sina PIRAMOON, San Jose, CA (US)

(21) Appl. No.: 18/252,385

(22) PCT Filed: Oct. 27, 2021
(86) PCT No.: PCT/US2021/056746

§ 371 Date: May 10, 2023

Related U.S. Application Data
(60) Provisional application No. 63/112,018, filed on Nov. 10, 2020.
(60) Provisional application No. 63/256,014, filed on Oct. 15, 2021.

(51) Int. Cl. B04B 5/04; B04B 7/02; B04B 9/14; B04B 7/08

(52) U.S. Cl. CPC B04B 5/0414; B04B 7/02; B04B 9/14; B04B 7/08; B04B 2007/025

(57) ABSTRACT

A rotor (10) for use in a centrifuge includes a rotor body (12), a drive hub (20), and a balance ring (16, 160). The rotor body (12) includes an elongated bore (32) extending along its axis of rotation (24), and an upper surface (26) having an annular groove (42). The drive hub (20) is mounted within the elongated bore (32), and includes a drive portion (138) having a cross-sectional shape that is complementary to the cross-sectional shape of the elongated bore (32). The drive hub (20) applies torque to the rotor body (12) via engagement of the drive portion (138) with the lower bore opening (36) of the rotor body (12). The balance ring (16, 160) is positioned in the annular groove (42), and includes a plurality of apertures (78, 163) formed in an upper surface (90, 170) thereof. Each of the apertures (78, 163) is configured to receive a weight (80, 164) so that the rotor (10) can be balanced by selectively adding weights (80, 164) to one or more of the apertures (78, 163).

### CROSS-REFERENCE TO RELATED APPLICATIONS

The present application claims the filing benefit of co-pending U.S. Provisional Applications having Ser. No. 63/112,018 filed on Nov. 10, 2020 and Ser. No. 63/256,014 filed on Oct. 15, 2021, the disclosures of which are each incorporated by reference herein in their entireties.

### TECHNICAL FIELD

The present invention relates generally to centrifuge rotors and, more particularly, to a rotor for ultracentrifugation.

### BACKGROUND

Exosomes are cell-derived vesicles that can carry nucleic acids, lipids, or proteins from one cell to another. Exosomes play an important role in communication between cells, and are necessary for the proper functioning of the human body. In addition to their role in the regular physiology of humans, exosomes are also connected with certain diseases. There has been growing interest in exosome research due to their role as intercellular messengers and their potential in both the diagnosis and treatment of disease. For example, because exosomes have different secretory components under physiological and pathological conditions, they have been studied as a therapeutic target, a drug or gene delivery vector, and a cancer marker.

Exosomes are a type of extracellular vesicle secreted from most cell types, and typically have diameters of between 30 nm and 140 nm. Exosomes are normally secreted along with other types of extracellular vesicles, such as apoptotic bodies having diameters of 50-500 nm, and ectosomes having diameters of 30-100 nm. Exosomes may be separated from these other types of extracellular vesicles using centrifugation. However, because these additional extracellular vesicles often have similar physical properties as exosomes (e.g., similar sizes and densities), isolating exosomes from other cellular secretions commonly found in biological suspensions can require extremely high g-forces.

The amount of g-force that can be generated by a centrifuge depends at least in part on the physical properties of the rotor. Minor imperfections such as uneven distributions in mass or minor structural defects that would not be an issue in conventional centrifuges can cause vibrations or failures at the rotational speeds desired to efficiently separate exosomes.

Thus, there is a need for improved rotors that can be used in ultracentrifugation applications for separating exosomes and other materials having similar physical properties.

### SUMMARY

The present invention overcomes the foregoing and other shortcomings and drawbacks of centrifuge rotors heretofore known for use in ultra-high-speed centrifugation. While the present invention will be discussed in connection with certain embodiments, it will be understood that the present invention is not limited to the specific embodiments described herein.

In an embodiment of the present invention, a rotor for use in a centrifuge is provided. The rotor includes a rotor body having an axis of rotation, an upper surface, a lower surface opposite the upper surface, and an elongated bore extending along the axis of rotation between the upper surface and the lower surface. The upper surface of the rotor body includes a plurality cavities extending from the upper surface and into the rotor body, each of the plurality of cavities being configured to receive a sample container. The lower surface of the rotor body includes a lower bore opening in communication with the elongated bore and having a first cross-sectional shape transverse to the axis of rotation. The rotor further includes a drive hub mounted within the elongated bore and having a drive portion with a second cross-sectional shape transverse to the axis of rotation that is complementary to the first cross-sectional shape such that the drive portion of the drive hub applies torque to the rotor body via engagement of the drive portion with the lower bore opening of the rotor body.

In an aspect of the present invention, each of the first cross-sectional shape and the second cross-sectional shape may be rectangular.

In another aspect of the present invention, the rotor body may include an upper bore opening in communication with the elongated bore, and the elongated bore may be cylindrical in cross-section transverse to the axis of rotation between the lower bore opening and the upper bore opening.

In another aspect of the present invention, the rotor may further include a lid having a central wall portion, a conical wall portion extending upwardly and outwardly from the central wall portion, and an annular wall portion extending radially outward from the conical wall portion remote from the central wall portion such that the annular wall portion is radially and axially offset from the central wall portion.

In another aspect of the present invention, the conical wall portion of the lid may be configured to engage each sample container placed into a respective cavity when the lid is operatively coupled to the rotor.

In another aspect of the present invention, the upper surface of the rotor body may define an upper recess, and the central and conical wall portions of the lid may be received in the upper recess.

In another aspect of the present invention, the lid may include a lid-lifting handle that projects axially upward from the central wall portion of the lid.

In another aspect of the present invention, the lid-lifting handle may include a cylindrical wall and a handle flange that projects radially outward from a free end of the cylindrical wall remote from the central wall portion of the lid.

In another aspect of the present invention, the drive hub may include a cylindrical shaft that projects upwardly through the elongated bore from the drive portion of the drive hub.

In another aspect of the present invention, an upper portion of the cylindrical shaft may include a threaded outer surface.

In another aspect of the present invention, the rotor may further include a lid screw having a lower bore with a threaded inner surface and a lid screw flange that extends radially outward from a lower end of the lid screw. The threaded outer surface of the drive hub may be configured to threadedly engage the threaded inner surface of the lower bore of the lid screw, and the lid screw flange may have a lower surface configured to urge the lid into contact with the rotor body in response to threaded engagement of the lid screw and the drive hub.

In another aspect of the present invention, the cylindrical wall of the lid-lifting handle may be configured to receive the lid screw flange and position the lid screw concentrically with the lid-lifting handle.

In another aspect of the present invention, the lower surface of the lid screw flange may include an annular groove, and the rotor may further include an elastic member positioned within the annular groove that is compressed against an upper surface of the central wall portion of the lid in response to threaded engagement of the lid screw with the drive hub.

In another aspect of the present invention, the lower bore opening may include one or more sidewalls, the drive portion of the drive hub may have one or more faces each engaging a respective sidewall of the lower bore opening, and the application of torque to the rotor body may be by the one or more faces engaging the respective sidewalls.

In another embodiment of the present invention, another rotor for use in a centrifuge is provided. The rotor includes a rotor body having an axis of rotation and an upper surface with a first annular groove, and a balance ring positioned in the first annular groove. The balance ring includes an upper surface and a plurality of apertures formed in the upper surface. Each aperture in the upper surface of the balance ring is configured to selectively receive a weight.

In another aspect of the present invention, the rotor body may include a lower surface opposite its upper surface and an elongated bore extending along the axis of rotation between the upper and lower surfaces of the rotor body, and the rotor may further include a drive hub mounted within the elongated bore and having a cylindrical shaft that projects upwardly through the elongated bore. The cylindrical shaft may include an upper portion having a threaded outer surface. The rotor may further include a lid screw having a lower bore with a threaded inner surface configured to threadedly engage the threaded outer surface of the drive hub and a lid screw flange that extends radially outward from a lower end of the lid screw, a lid including a wall portion extending radially outward and including a lower surface having a second annular groove, and an elastic member positioned within the second annular groove that is compressed against the upper surface of the balance ring in response to threaded engagement of the lid screw with the drive hub.

In another aspect of the present invention, the threaded outer surface may include threads having a major diameter and a minor diameter, and the cylindrical shaft may include a protruding end having the minor diameter and that extends a distance beyond the threads of the threaded outer surface.

In another aspect of the present invention, the first annular groove may include a shoulder, and the balance ring may include a balance ring flange that projects radially inward to engage the shoulder.

In another aspect of the present invention, the rotor body may include a circumferential sidewall, and the rotor may further include a reinforcement that extends around the circumferential sidewall.

In another aspect of the present invention, the reinforcement may extend around and above the circumferential sidewall of the rotor body to define a channel with the first annular groove, and the balance ring may be positioned in the channel.

In another aspect of the present invention, the circumferential sidewall may include a circumferential recess, and the reinforcement may conform to the circumferential recess.

In another aspect of the present invention, the balance ring may be operatively coupled to the first annular groove by an adhesive, a shrink-fit, or both the adhesive and the shrink-fit.

In another aspect of the present invention, each aperture may be spaced the same angular distance from each angularly adjacent aperture.

In another aspect of the present invention, the plurality of apertures may be arranged into a plurality of aperture groups each including two or more apertures separated by a first angular distance, and each aperture group may be separated from each adjacent aperture group by a second angular distance different from the first angular distance.

In another aspect of the present invention, the balance ring may further include a plurality of markers on its upper surface, and each marker may be positioned between two aperture groups.

In another aspect of the present invention, the rotor body may further include a plurality cavities extending from its upper surface into the rotor body, each of the plurality of cavities may be configured to receive a sample container, and each marker may be radially aligned with a respective cavity.

In another aspect of the present invention, the rotor may further include at least one weight received by at least one of the apertures.

In another aspect of the present invention, the at least one weight may be a screw including a threaded outer surface, and each of the apertures may include a threaded inner surface configured to threadedly engage the screw.

In another aspect of the present invention, the screw may have a head and a first length, the at least one aperture may have a second length longer than the first length, and the head of the screw may be below the upper surface of the balance ring.

In another aspect of the present invention, each aperture of the plurality of apertures may be the same radial distance from the axis of rotation.

### BRIEF DESCRIPTION OF THE DRAWINGS

The accompanying drawings, which are incorporated in and constitute a part of this specification, illustrate embodiments of the present invention and, together with the general description of the present invention given above, and the detailed description given below, serve to explain the present invention.

FIG. 1 is a perspective view of a rotor in accordance with an exemplary embodiment of the present invention.

FIG. 2 is an exploded perspective view of the rotor of FIG. 1 showing a rotor body, a balance ring, a drive hub, and a lid of the rotor.

FIG. 2A is a perspective view showing additional details of the lid of FIG. 2.

FIG. 2B is a top perspective view showing additional details of the rotor body of FIG. 2.

FIG. 2C is a bottom perspective view showing additional details of the rotor body and drive hub of FIG. 2.

FIG. 3 is a cross-sectional view of the rotor of FIG. 1.

FIG. 3A is an exploded cross-sectional view of a portion of the rotor of FIG. 3 showing additional details of the lid, balance ring, and rotor body.

FIGS. 4 and 5 are top views of the rotor of FIG. 1 with the lid removed.

FIG. 6 is a top view of the rotor of FIG. 1 with the lid removed showing a balance ring in accordance with an alternative embodiment of the present invention.

FIG. 6A is a cross-sectional view of the balance ring of FIG. 6.

FIG. 7 is a top view of the rotor of FIG. 6 with the lid removed showing the balance ring with the weight installed in an aperture.

FIG. 7A is a cross-sectional view of the balance ring of FIG. 7 showing the weight installed in the aperture.

### DETAILED DESCRIPTION

Embodiments of the present invention are directed to a rotor suitable for use in ultracentrifugation.

Ultracentrifugation uses differences in the sedimentation rate of particles, which may be affected by the size, density, and shape of the particles, to separate sample components suspended in a liquid. Centrifugal forces may be applied in steps to separate sample components sequentially according to their physical properties. Because sedimentation rates are dependent at least in part on the size of the particles, smaller particles may be isolated from larger particles using a series of sequentially increasing centrifugation speeds. By way of example, relatively low g-forces (e.g., 300-1,000×g) may be applied to remove cells, cell debris, and other large particles from a sample of the suspension. The remaining supernatant may then be aspirated and subjected to subsequent rounds of centrifugation at increasing g-forces, with each round separating out progressively smaller particles. Ultracentrifugation producing high g-forces (e.g., up to 1,000,000×g) may be used in later rounds of centrifugation to obtain a pellet of the desired material. Density gradient separation using ultracentrifugation may also be used to isolate or purify sample components.

Embodiments of the present invention include rotors that provide improved uniformity in the distribution of mass with respect to their respective axes of rotation, increased strength, and reduced overall mass as compared to conventional rotors. The low levels of vibration and high g-forces (e.g., 200,000×g at 50,000 to 60,000 RPM) enabled by these rotors may allow improved isolation and purification processes for materials suspended in biological fluids, such as cells, exosomes, mitochondria, and other organelles.

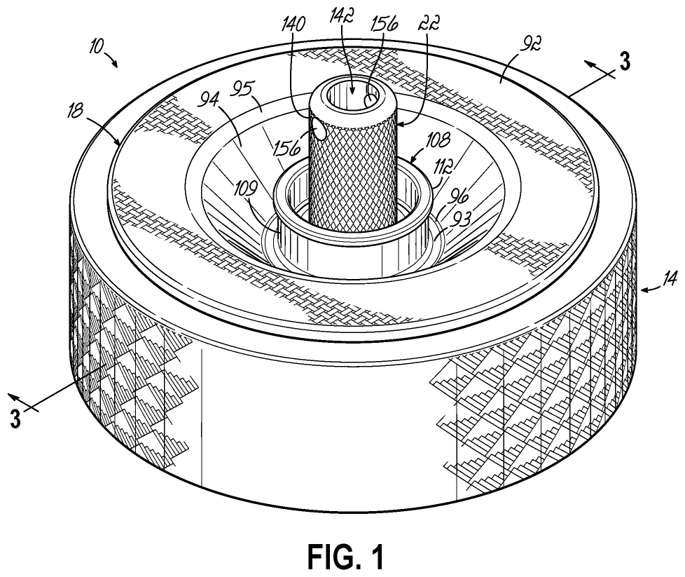

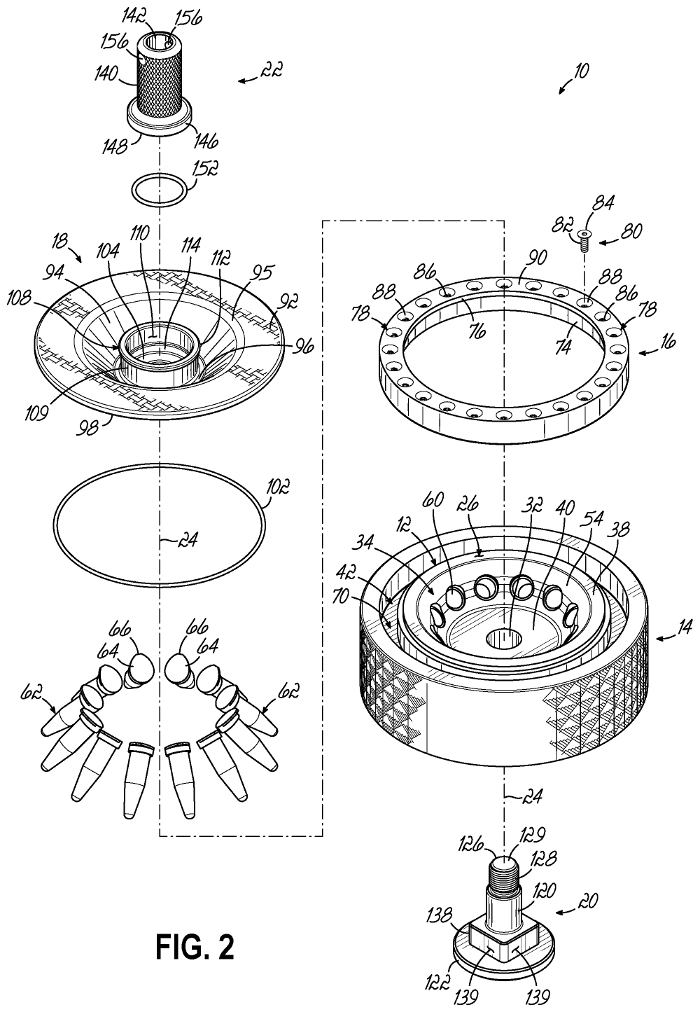

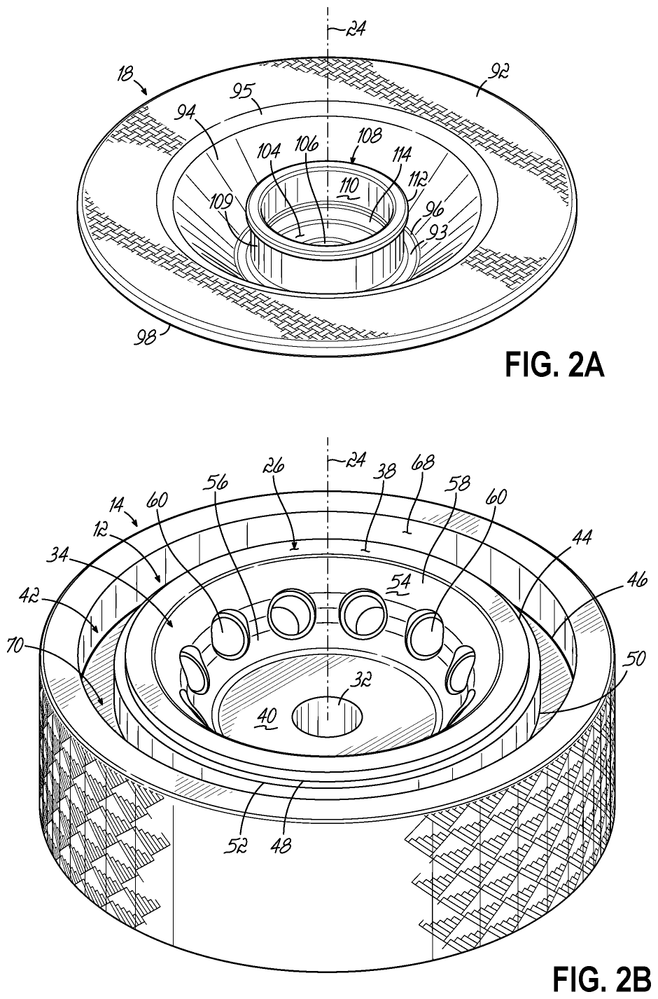

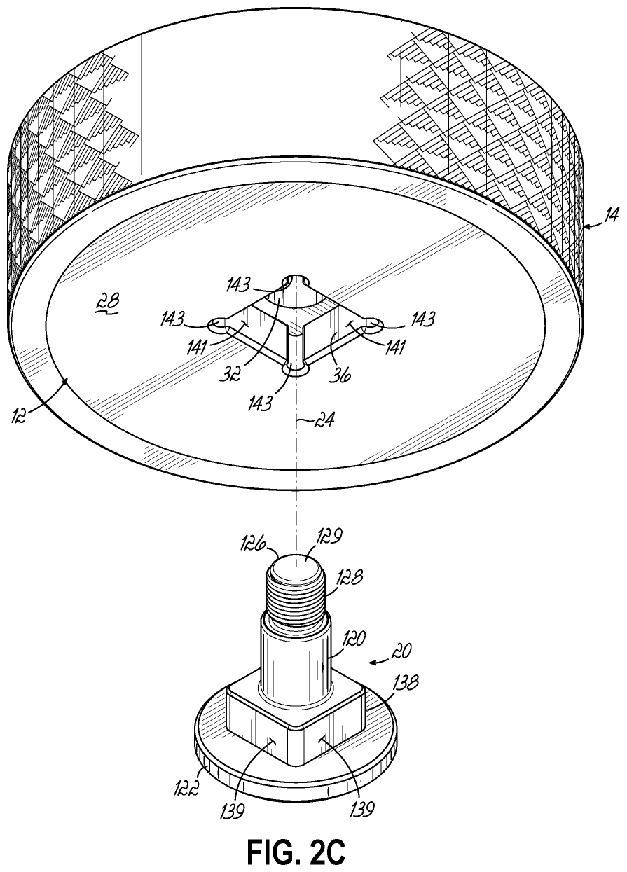

FIGS. 1-5 depict a rotor 10 in accordance with an exemplary embodiment of the present invention. As best shown by FIG. 2, the rotor 10 includes a rotor body 12, a reinforcement 14, a balance ring 16, a lid 18, a drive hub 20, and a lid screw 22. The rotor 10 has an axis of rotation 24 about which the rotor 10 is configured to rotate when used in a centrifuge, and about which the components of the rotor 10 are concentrically arranged.

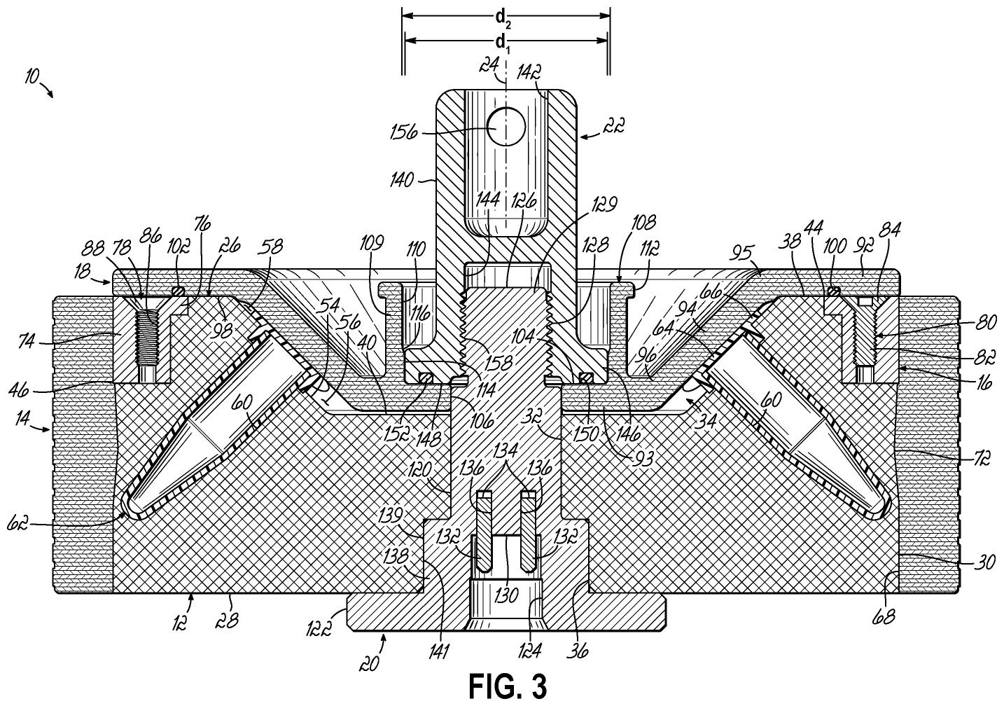

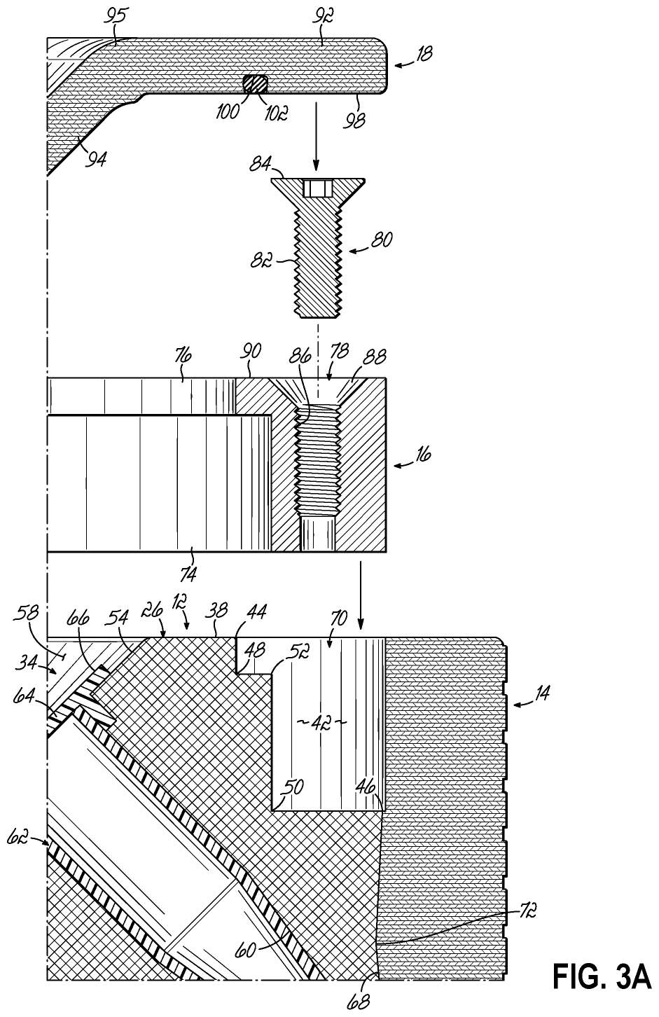

As best shown by FIGS. 2B and 3, the rotor body 12 may be made from a carbon fiber composite or other suitable lightweight, rigid material, and includes an upper surface 26, a lower surface 28, a circumferential sidewall 30, and an elongated bore 32 that passes through the upper and lower surfaces 26, 28. The elongated bore 32 may be axially aligned with the axis of rotation 24, and intersects an upper recess 34 in the upper surface 26 and a lower bore opening 36 in the lower surface 28 of rotor body 12. As described in more detail below, the lower bore opening 36 may have a horizontal cross sectional shape that is keyed to the drive hub 20 to prevent rotation of the rotor body 12 relative to the drive hub 20.

The upper surface 26 of rotor body 12 may include an annular surface 38, a central surface 40 that is recessed axially downward relative to the annular surface 38, and an annular groove 42. The annular groove 42 may define an outer perimeter 44 of the annular surface 38 and an upper edge 46 of the circumferential sidewall 30. The annular groove 42 may be defined by an upper rabbet 48 and a lower rabbet 50 that overlap to define a shoulder 52. The central surface 40 may be connected to the annular surface 38 by a connecting surface 54. The connecting surface 54 may extend axially upward and radially outward from an outer perimeter of the central surface 40 to an inner perimeter of the annular surface 38. The connecting surface 54 may be oriented such that it faces axially upward and radially inward, and may include a lower portion 56 and an upper portion 58. The upper portion 58 of connecting surface 54 may be elevated above the lower portion 56 in a direction normal to the connecting surface 54.

The rotor body 12 may further include a plurality of cavities 60 each extending axially downward and radially outward from the lower portion 56 of connecting surface 54 and into the rotor body 12. Each cavity 60 may have a central axis that is normal to the connecting surface 54, and be suitably sized and shaped receive a sample container 62. Each cavity 60 may be configured to hold its respective sample container 62 in a suitable position and orientation for centrifugation, e.g., at a 45 degree angle relative to the axis of rotation 24. Each sample container 62 may be configured to hold an amount of a sample suspension (e.g., 1.5 ml) and include a cap 64 that seals the sample container 62 when pressed into a closed position. The cap 64 may include a tab 66 configured to facilitate opening of the sample container 62. The cavity 60, sample container 62, and cap 64 may be configured so that when the sample container 62 is fully inserted into its respective cavity 60, the tab 66 is supported by the upper portion 58 of connecting surface 54. Advantageously, the upper portion 58 of connecting surface 54 may prevent high g-forces generated by centrifugation from causing deflection of the cap 64, which could potentially break the seal between the cap 64 and the body of the sample container 62 or damage the sample container 62.

As best shown by FIG. 3, the reinforcement 14 may include one or more helical windings that extend around and above the circumferential sidewall 30 of rotor body 12. An inner surface 68 of reinforcement 14 may operate cooperatively with the annular groove 42 of rotor body 12 to define a channel 70 in which the balance ring 16 is positioned. The reinforcement 14 may be formed by a filament winding process followed by a compression molding process using a suitable material, such as an epoxy-coated carbon fiber. For example, the reinforcement 14 may be compression molded onto the rotor body 12 and balance ring 16 after placing layers of resin-coated carbon fiber laminate material, or winding one or more strands of carbon fiber, onto the outwardly-facing surface of circumferential sidewall 30.

To prevent the reinforcement 14 from moving axially, the circumferential sidewall 30 may include an inward taper that defines a circumferential recess 72 in the circumferential sidewall 30. The inner surface 68 of reinforcement 14 may conform to the circumferential recess 72 so that reinforcement 14 resists axial movement relative to the rotor body 12. The reinforcement 14 may be configured to bear the majority of the centrifugal forces placed on the rotor 10. Methods of forming reinforcements for centrifugal rotors using a filament winding process are described in detail by U.S. Pat. No. 8,323,169, issued Dec. 4, 2012, the disclosure of which is incorporated by reference herein in its entirety.

As best shown by FIG. 3A, the balance ring 16 may include a body 74 having a rectangular cross section and a flange 76. The flange 76 may project radially inward from a top portion of the body 74 of balance ring 16, and may be configured to engage the shoulder 52 of rotor body 12. The balance ring 16 may be heated so that it expands before placing it on the annular groove 42, and allowed to cool in place so that it is held to the rotor body 12 by a shrink-fit. The balance ring 16 may be placed in the annular groove 42 of rotor body 12 prior to forming the reinforcement 14 so that the reinforcement 14 holds the balance ring 16 in place. An adhesive may also be used to operatively couple the balance ring 16 to the surface of the annular groove 42. The adhesive may be used alone or in combination with the shrink fit.

The balance ring 16 may include a plurality of apertures 78 each configured to receive a weight 80. One or more weights 80 may be selectively positioned in one or more of the apertures 78 of balance ring 16 in order to balance the rotor 10. In an embodiment of the present invention, each weight 80 may include a threaded shaft 82 and a head 84. Each aperture 78 may include a threaded bore 86 configured to receive the threaded shaft 82 of weight 80, and a receptacle 88 (e.g., a countersink, counterbore, or the like) configured to receive the head 84 of weight 80. The receptacle 88 may thereby allow the top of the weight 80 to be flush with or recessed below an upper surface 90 of the balance ring 16 when the weight 80 is fully inserted into the aperture 78.

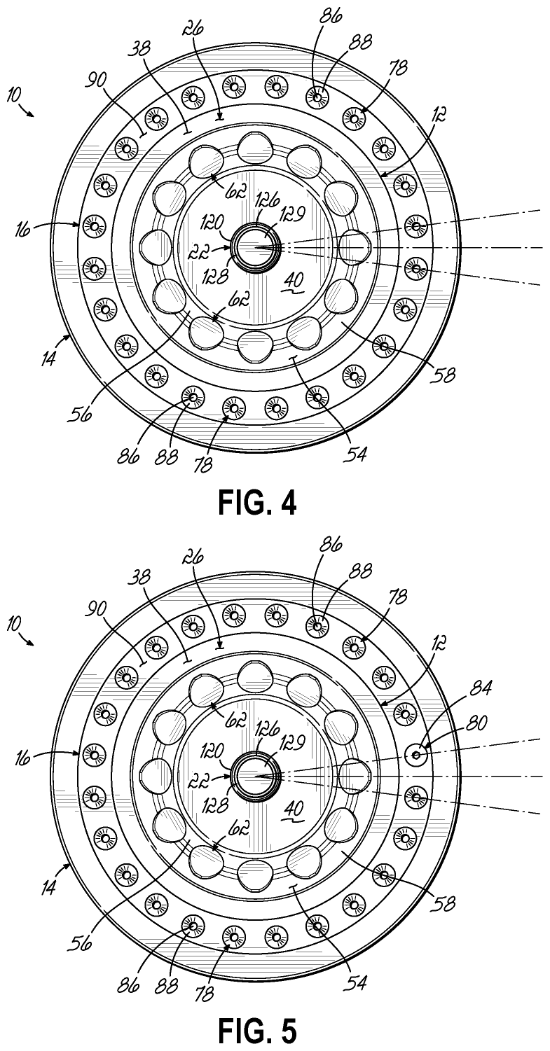

As best shown by FIGS. 4 and 5, the balance ring 16 may be angularly positioned about the axis of rotation 24 with respect to the rotor body 12 such that the apertures 78 of balance ring 16 are symmetrically positioned relative to the cavities. This symmetry may result in each of the two apertures 78 closest to a respective cavity 60 of rotor body 12 being an equal distance from, and on opposite sides of, a line extending radially outward from the axis of rotation 24 and passing thorough the central axis of the cavity 60. This angular positioning of the balance ring 16 may provide the ring with an orientation such that each cavity 60 of rotor body 12 is angularly centered between the two apertures 78 of balance ring 16 closest to the cavity 60, and ensure positional symmetry between the cavities 60 of rotor body 12 and the apertures 78 of balance ring 16.

As best shown by FIG. 2A, the lid 18 of rotor 10 may include an annular wall portion 92, a central wall portion 93, and a conical wall portion 94, and may be made of a carbon fiber composite, aluminum, or any other suitable rigid low-mass material. The conical wall portion 94 of lid 18 may connect an inner edge 95 of the annular wall portion 92 to an outer edge 96 of the central wall portion 93. The conical wall portion 94 may be joined to each of the annular wall portion 92 and the central wall portion 93 of lid 18 at an obtuse angle such that the annular wall portion 92 is offset axially from, and is parallel to, the central wall portion 93. The resulting shape of the lid 18 may generally conform to that of the upper surface 26 of rotor body 12.

Referring again to FIG. 3A, and with continued reference to FIG. 2A, the annular wall portion 92 of lid 18 may include a lower surface 98 having an annular groove 100 that is configured to receive an elastic member 102, e.g., an O-ring. The elastic member 102 may be made of any suitable material (e.g., silicone), and may be configured to engage the upper surface 90 of balance ring 16 when the lid 18 is operatively coupled to the rotor 10.

The central wall portion 93 of lid 18 may include an upper surface 104, a central bore 106, and a lid-lifting handle 108 that projects axially upward from the upper surface 104. The central bore 106 may have the same diameter as the elongated bore 32 of rotor body 12 so that the bores are axially aligned by the drive hub 20. The lid-lifting handle 108 may include a cylindrical wall 109 having an inner surface 110, and a flange 112. The cylindrical wall 109 may be joined to the lid 18 at a lower end thereof. The flange 112 may project radially outward from an upper portion of the lid-lifting handle 108 at a free end of the cylindrical wall 109 remote from the central wall portion 93 of lid 18 to provide a grip for grasping the rotor 10. This grip may improve the ergonomics of installing of the rotor 10 in, and removing the rotor 10 from, a centrifuge as compared to rotors lacking this feature. The inner surface 110 of cylindrical wall 109 may include a neck 114 proximate or adjacent to the upper surface 104. The neck 114 may have a diameter d₁ which is less than the diameter d₂ of the main portion of inner surface 110. The main portion of inner surface 110 may be joined to the neck 114 by a bevel 116.

As best shown by FIG. 2C, the drive hub 20 may include a shaft 120, a flange 122 that projects radially outward from a bottom portion of the shaft 120, and a center bore 124 which extends axially into a bottom end of the shaft 120. The center bore 124 of drive hub 20 may be axially aligned with the axis of rotation 24 of rotor 10, include a bottom surface 130, and be configured to receive a spindle of the centrifuge (not shown). An upper portion 126 of shaft 120 may be configured to receive the lid screw 22. To this end, the upper portion 126 of shaft 120 may include a threaded outer surface 128 configured to threadedly engage the lid screw 22.

A portion of the shaft 120 adjacent to and below the threaded outer surface 128 may have a reduce radius (e.g., an undercut) to provide thread relief. This thread relief may ensure a lower surface 148 of a flange 146 of lid screw 22 engages the upper surface 104 of the central wall portion 93 of lid 18 without interference from the shaft 120 when the lid screw 22 is threadedly engaged with the drive hub 20. The upper portion 126 of shaft 120 may include a protruding end 129 at the top thereof. The protruding end 129 may have a diameter about the same as the minor diameter of the threaded outer surface 128, and extend a distance of 1.5 to 2.5 thread widths beyond the threads of the threaded outer surface 128. The drive hub 20 may be manufactured from a solid billet of metal using computer numerical control (CNC) machining, for example, or using any other suitable process.

Referring again to FIG. 3, and with continued reference to FIG. 2C, to prevent the drive hub 20 from rotating relative to the spindle, one or more drive-pins 132 may extend axially downward from the bottom surface 130 of center bore 124. Each drive-pin 132 may be configured to engage a respective receptacle in the spindle of the centrifuge. Each drive-pin 132 may comprise a rod 134 inserted into a respective bore 136 that extends axially into the bottom surface 130 of center bore 124. Each bore 136 may be offset radially from the center axis of center bore 124. This offset may cause the drive-pins 132 to be subjected to a shearing force in response to the spindle applying torque to the rotor 10 that would be sufficient to, absent the drive-pins 132, cause slippage between the spindle and drive hub 20.

A drive portion 138 of hub 20 may extend axially upward from the flange 122 and radially outward from the shaft 120. The drive portion 138 of hub 20 may have a horizontal cross sectional shape that is keyed, or is otherwise complementary, to the horizontal cross sectional shape of the lower bore opening 36 of rotor body 12. Keying the drive portion 138 to the lower bore opening 36 may prevent the angular position of the rotor body 12 from shifting relative to the drive hub 20 under angular acceleration. To this end, the cross sectional shape of the drive portion 138 may be the same as that of the lower bore opening 36, a different shape that fits within the lower bore opening 36 and has one or more faces 139 that engage corresponding faces 141 in a sidewall of the lower bore opening 36, or that is otherwise keyed to the cross sectional shape of the lower bore opening 36.

For example, the cross sectional shape of the drive portion 138 may be a polygon (e.g., a square) having the same number of faces 139, or more faces 139, than the shape of the lower bore opening 36. By way of example, for a lower bore opening 36 having a square-shaped horizontal cross-section, the drive portion 138 may have a square-shaped, an octagonal-shaped, or other cross-sectional shape having one or more faces 139 complementary to the faces 141 of lower bore opening 36. The lower bore opening 36 may also include one or more axially-aligned channels 143 positioned where the vertexes of the faces 141 would otherwise be to facilitate insertion of the drive portion 138 of drive hub 20 into the lower bore opening 36.

As best shown by FIG. 3, the lid screw 22 may be made from any suitable material (e.g., aluminum), and comprises a cylindrical body having an outer surface 140, an upper bore 142, a lower bore 144, and the flange 146 that projects radially outward from a lower end of the cylindrical body. The flange 146 may have an outer diameter the same as or slightly less than the diameter d₁ of neck 114. The bevel 116 may guide the flange 146 into the neck 114 as the flange 146 is inserted into the lid-lifting handle 108 and the lid screw 22 screwed onto the drive hub 20. The neck 114 and bevel 116 may thereby work cooperatively with the flange 146 to position the lid screw 22 concentrically with the lid 18 and drive hub 20, thereby aligning the lid 18 with the axis of rotation 24 of rotor 10 during engagement of the lid screw 22 with the drive hub 20. The final alignment between the lid 18 and the axis of rotation 24 of rotor 10 may be defined by the engagement of the shaft 120 of drive hub 20 and the central bore 106 of lid 18.

The flange 146 may include the lower surface 148, and the lower surface 148 may have an annular groove 150 configured to receive an elastic member 152. The elastic member 152 may be an O-ring or other type of gasket made of a suitable material, such as silicone. The elastic member 152 may be compressed against the upper surface 104 of the central wall portion 93 of lid 18 in response to tightening the lid screw 22 against the drive hub 20. The elastic member 152 may thereby urge the lid 18 into operable engagement with the rotor 10.

The lid screw 22 may further include one or more pairs of radially-aligned holes 156 on opposing sides of the upper bore 142. The radially-aligned holes 156 may be configured to receive a rod or other tool for applying torque to the lid screw 22. The radially-aligned holes 156 may thereby facilitate tightening the lid screw 22 to the drive hub 20, and loosening the lid screw 22 from the drive hub 20.

The lower bore 144 of lid screw 22 may include a threaded inner surface 158 configured to threadedly engage the threaded outer surface 128 of drive hub 20. The protruding end 129 of shaft 120 may facilitate this threaded engagement between the drive hub 20 and lid screw 22 by providing a clean start to engagement between the threaded outer surface 128 of shaft 120 and the threaded inner surface 158 of lower bore 144. Threadedly engaging the lid screw 22 with the drive hub 20 may urge the lid 18 against at least a portion of the upper surface 26 of rotor body 12. The lid screw 22 may also urge the lid 18 against the caps 64 of sample containers 62, thereby maintaining the caps 64 fully seated on the sample containers 62. In this way, the lid 18 may also hold the sample containers 62 in a fully seated position within their respective cavities 60 by applying a nominal force to the surface of each cap 64.

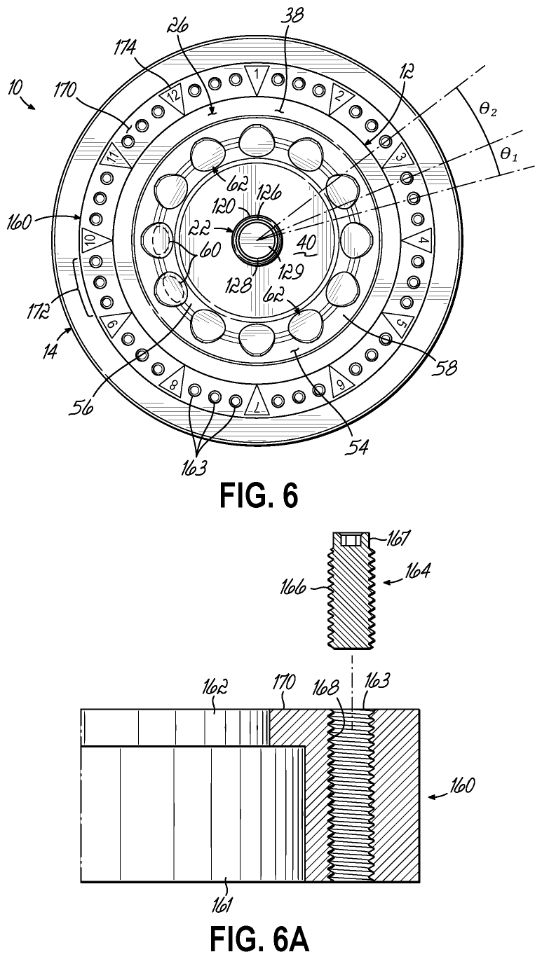

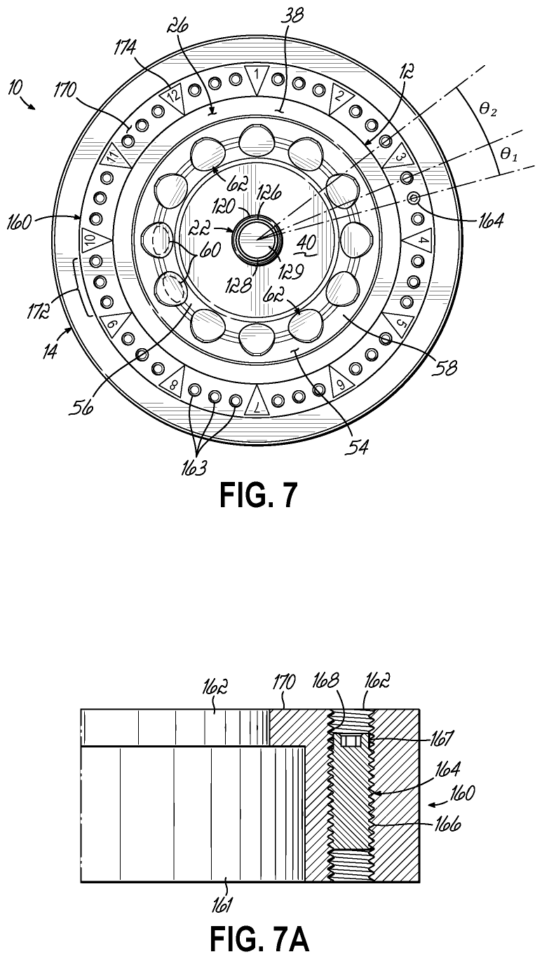

FIGS. 6 and 7 depict top views of the rotor 10 without the lid 18, and FIGS. 6A and 7A depict cross-sectional views of a balance ring 160 in accordance with an alternative embodiment of the present invention. The balance ring 160 may include a body 161 having a rectangular cross section, a flange 162, and a plurality of apertures 163 each configured to receive a weight 164. Each weight 164 may include a threaded shaft 166 and a head 167 configured to receive a tool, e.g., a hex key. Each aperture 163 may include a threaded bore 168 configured to receive the weight 164. The threaded bore 168 may have a length greater than the length of the weight 164, thereby allowing the position of the weight 164 within the threaded bore 168 to be selectively adjusted by rotating the weight 164 in one of a clockwise or counter-clockwise direction. This ability to adjust the position of each weight 164 in an axial direction relative to an upper surface 170 of the balance ring 160 may facilitate achieving dynamic balance of the rotor 10. The head 167 of weight 164 may be configured so that the head 167 can be positioned below the upper surface 170 of balance ring 160. This may allow the weight 164 to be positioned anywhere within the threaded bore 168. The weights 164 may comprise, for example, set screws made from a suitable material, such 316 stainless steel. Different length set screws may be used to provide weights 164 having different masses. By way of example, metric SST-316 set screws sized M4×0.7 come in variety of lengths, and provide excellent maps for balancing.

The apertures 163 may be located a fixed radial distance from the axis of rotation 24 of rotor 10, and may be arranged in aperture groups 172. By way of example, the balance ring 160 may include 36 apertures 163 arranged in 12 aperture groups 172, with each aperture group 172 having three apertures 163. Each aperture 163 may be a fixed angular distance θ₁ (e.g., 7.5 degrees) from angularly adjacent apertures 163 within the same aperture group 172. Each aperture group 172 may be a fixed angular distance θ₂ (e.g., 15 degrees) from angularly adjacent aperture groups 172. Each aperture group 172 may provide a plurality (e.g., three) balancing locations, and may be located between two adjacent cavities 60. A marker 174 may be located between each aperture group 172, and may include numerals other indicia that uniquely identifies each cavity 60 in the rotor.

The balance ring 160 may be angularly positioned about the axis of rotation 24 with respect to the rotor body 12 such that the apertures 163 of balance ring 160 are symmetrically positioned relative to the cavities 60. This symmetry may result in each aperture group 172 closest to a respective cavity 60 of rotor body 12 being an equal distance from, and on opposite sides of, a line extending radially outward from the axis of rotation 24 and passing thorough the central axis of the cavity 60. This angular positioning of the balance ring 16 may provide the ring with an orientation such that each cavity 60 of rotor body 12 is angularly centered between the two aperture groups 172 closest to the cavity 60, and ensure positional symmetry between the cavities 60 of rotor body 12 and the apertures 163 of balance ring 160.

Balance rings 16, 160 may be made from aluminum or any other suitable lightweight rigid material. One or more weights 80, 164 may be selectively placed into respective apertures 78, 163 to offset imbalances in the rotor 10. For example, weights 80, 164 may be added to align the center of mass of the rotor 10 with the axis of rotation 24 (i.e., to achieve static balance), to align a principal axis of the rotor's moment of inertia with the axis of rotation 24 (i.e., dynamic balance), or so that the rotor 10 is both statically and dynamically balanced.

Although each of the exemplary embodiments of the rotor 10 described herein include specific numbers of cavities 60, apertures 78, 163, aperture groups 172, and spacings, it should be understood that embodiments of the present invention are not limited to a specific number of cavities 60, apertures 78, 163, or aperture groups 172. It should be further understood that the depicted embodiments of the apertures 78, 163 are not limited to the arrangements depicted in their respective balance rings 16, 160. For example, the apertures 163 depicted in FIGS. 6-7A may be used in the balance ring 16 depicted in FIGS. 3A-5, and the apertures 78 depicted in FIGS. 3A-5 may be used in the balance ring 160 depicted in FIGS. 6-7A.

While various aspects in accordance with the principles of the present invention have been illustrated by the description of various embodiments, and while the embodiments have been described in considerable detail, they are not intended to restrict or in any way limit the scope of the present invention to such detail. The various features shown and described herein may be used alone or in any combination. Additional advantages and modifications will readily appear to those skilled in the art. The present invention in its broader aspects is therefore not limited to the specific details, representative apparatus and methods and illustrative examples shown and described. Accordingly, departures may be made from such details without departing from the scope of the general inventive concept.

What is claimed is:

1. A rotor for use in a centrifuge, comprising:
a rotor body including an axis of rotation, an upper surface, a lower surface opposite the upper surface, and an elongated bore extending along the axis of rotation between the upper surface and the lower surface, the upper surface of the rotor body including a plurality of cavities extending from the upper surface and into the rotor body, each of the plurality of cavities being configured to receive a sample container, and the lower surface of the rotor body including a lower bore opening in communication with the elongated bore and having a first cross-sectional shape transverse to the axis of rotation; and
a drive hub mounted within the elongated bore and including a drive portion having a second cross-sectional shape transverse to the axis of rotation that is complementary to the first cross-sectional shape such that the drive portion of the drive hub applies torque to the rotor body via engagement of the drive portion with the lower bore opening of the rotor body.

2. The rotor of claim 1, wherein the first cross-sectional shape and the second cross-sectional shape are each rectangular.

3. The rotor of claim 1, wherein:
the rotor body includes an upper bore opening in communication with the elongated bore, and the elongated bore is cylindrical in cross-section transverse to the axis of rotation between the lower bore opening and the upper bore opening.

4. The rotor of claim 1, further comprising:
a lid including a central wall portion, a conical wall portion extending upwardly and outwardly from the central wall portion, and an annular wall portion extending radially outward from the conical wall portion remote from the central wall portion such that the annular wall portion is radially and axially offset from the central wall portion.

5. The rotor of claim 4, wherein the conical wall portion of the lid is configured to engage each sample container placed into a respective cavity when the lid is operatively coupled to the rotor.

6. The rotor of claim 4, wherein the upper surface of the rotor body defines an upper recess, and the central wall portion and the conical wall portion of the lid are received in the upper recess.

7. The rotor of claim 4, wherein the lid includes a lid-lifting handle that projects axially upward from the central wall portion of the lid.

8. The rotor of claim 7, wherein the lid-lifting handle includes a cylindrical wall having a handle flange projecting radially outward from a free end of the cylindrical wall remote from the central wall portion of the lid.

9. The rotor of claim 8, wherein the drive hub includes a cylindrical shaft that projects upwardly through the elongated bore from the drive portion of the drive hub.

10. The rotor of claim 9, wherein an upper portion of the cylindrical shaft includes a threaded outer surface having threads with a major diameter and a minor diameter, and the cylindrical shaft includes a protruding end having the minor diameter and that extends a distance beyond the threads of the threaded outer surface.

11. The rotor of claim 10, further comprising:
a lid screw including a lower bore having a threaded inner surface, and a lid screw flange that extends radially outward from a lower end of the lid screw,
wherein the threaded outer surface of the drive hub is configured to threadedly engage the threaded inner surface of the lower bore of the lid screw, and
the lid screw flange has a lower surface configured to urge the lid into contact with the rotor body in response to threaded engagement of the lid screw and the drive hub.

12. The rotor of claim 11, wherein the cylindrical wall of the lid-lifting handle is configured to receive the lid screw flange and position the lid screw concentrically with the lid-lifting handle.

13. The rotor of claim 11, wherein the lower surface of the lid screw flange includes an annular groove, and further comprising an elastic member positioned within the annular groove that is compressed against an upper surface of the central wall portion of the lid in response to threaded engagement of the lid screw with the drive hub.

14. The rotor of claim 1, wherein the lower bore opening includes one or more sidewalls, the drive portion of the drive hub has one or more faces each engaging a respective sidewall of the lower bore opening, and the application of torque to the rotor body is by the one or more faces engaging the respective sidewalls.

15. A rotor for use in a centrifuge, comprising:
a rotor body including an axis of rotation and an upper surface having a first annular groove; and
a balance ring positioned in the first annular groove, the balance ring including an upper surface and a plurality of apertures formed in the upper surface of the balance ring, each aperture configured to selectively receive a weight.

16. The rotor of claim 15, wherein the rotor body includes a lower surface opposite the upper surface of the rotor body and an elongated bore extending along the axis of rotation between the upper and lower surfaces of the rotor body, and further comprising:
a drive hub mounted within the elongated bore and including a cylindrical shaft that projects upwardly through the elongated bore, the cylindrical shaft including an upper portion having a threaded outer surface;
a lid screw including a lower bore having a threaded inner surface configured to threadedly engage the threaded outer surface of the drive hub, and a lid screw flange that extends radially outward from a lower end of the lid screw;
a lid including a wall portion extending radially outward, the wall portion including a lower surface having a second annular groove; and
an elastic member positioned within the second annular groove that is compressed against the upper surface of the balance ring in response to threaded engagement of the lid screw with the drive hub.

17. The rotor of claim 16, wherein the threaded outer surface includes threads having a major diameter and a minor diameter, and the cylindrical shaft includes a protruding end having the minor diameter and that extends a distance beyond the threads of the threaded outer surface.

18. The rotor of claim 15, wherein the first annular groove includes a shoulder, and the balance ring includes a balance ring flange that projects radially inward to engage the shoulder.

19. The rotor of claim 15, wherein the rotor body includes a circumferential sidewall, and further comprising:
a reinforcement that extends around the circumferential sidewall.

20. The rotor of claim 19, wherein the reinforcement extends around and above the circumferential sidewall of the rotor body to define a channel with the first annular groove, and the balance ring is positioned in the channel.

21. The rotor of claim 19, wherein the circumferential sidewall includes a circumferential recess, and the reinforcement conforms to the circumferential recess.

22. The rotor of claim 15, wherein the balance ring is operatively coupled to the first annular groove by an adhesive, a shrink-fit, or both the adhesive and the shrink-fit.

23. The rotor of claim 15, wherein each aperture is spaced the same angular distance from each angularly adjacent aperture.

24. The rotor of claim 15, wherein the plurality of apertures is arranged into a plurality of aperture groups each including two or more apertures separated by a first angular distance, and each aperture group is separated from each adjacent aperture group by a second angular distance different from the first angular distance.

25. The rotor of claim 24, wherein the balance ring further includes a plurality of markers on the upper surface of the balance ring, and each marker is positioned between two aperture groups.

26. The rotor of claim 25, wherein the rotor body further includes a plurality of cavities extending from the upper surface of the rotor body into the rotor body, each of the plurality of cavities is configured to receive a sample container, and each marker is radially aligned with a respective cavity.

27. The rotor of claim 15, further comprising:
at least one weight received by at least one of the apertures.

28. The rotor of claim 27, wherein the at least one weight is a screw including a threaded outer surface, and each of the apertures includes a threaded inner surface configured to threadedly engage the screw.

29. The rotor of claim 28, wherein the screw has a head and a first length, the at least one aperture has a second length longer than the first length, and the head of the screw is below the upper surface of the balance ring.

30. The rotor of claim 15, wherein each aperture of the plurality of apertures is the same radial distance from the axis of rotation.
